(19) United States
(12) Patent Application Publication
(10) Pub. No.: US 2007/0049363 A1
(43) Pub. Date: Mar. 1, 2007

(54) System and method for remotely controlling a device or system with voice commands

(76) Inventors: Howard D. Green, San Jose, CA (US); Lloyd C. Green, Spofford, NH (US)

Correspondence Address: STEVENS LAW GROUP, P.O. BOX 1667, SAN JOSE, CA, 95109, US

(21) Appl. No.: 11/509,142

(22) Filed: Aug. 23, 2006

Related U.S. Application Data
(60) Provisional application No. 60/711,052, filed on Aug. 23, 2005.

(51) Int. Cl. H04M 1/00

(52) U.S. Cl. 455/575.2

(57) ABSTRACT

A remote command system is provided for controlling a device, for example a device or machine used in a manufacturing process. The system may include one headset with a microphone or a plurality of wireless headsets each having a microphone and configured to receive voice sounds from a user and a transmission unit configured to transmit voice signals in response to the voice sounds. A controller interface unit may be configured to receive the voice signals from the wireless headsets and to transmit control signals, where the controller interface is further configured to be trained to receive and interpret voice signals having personal characteristics of a user. A processor module is configured to receive the control signals from the controller interface unit to operate the device or machine.

### BACKGROUND

The invention relates generally to voice operation of electronic and manually controlled devices, and, more particularly, to voice control of manufacturing equipment within a factory or manufacturing environment. The invention may further extend to voice operation of devices for use in assisted living environments.

Many manual and even automated controls exist for manufacturing equipment. However, many of these control devices have drawbacks. Many manufacturing devices are controlled by foot and hand pedals that require an operator to manually control different functions of a piece of equipment. For example, a welding device is typically operated by foot and hand pedals that require an operator to constantly manage the operation of the welding machine manually. Electronic controls exist where buttons can be pushed and different switches can be thrown in order to operate a welding device, or other similar devices, but an operator is still prone to dangerous accidents in the operation of such devices.

For example, if a system uses a foot control, there is a danger of inadvertent activation by an operator. Such an inadvertent activation may be caused by accidentally pressing a foot pedal when not intended. Some of these inadvertent activations may be caused by hitting the pedal when the pedal is not guarded. It also may be caused by slipping off the pedal, causing a failure of activation. Such missing may also cause back injury in a worker. Another phenomena of pedal operation, particularly when operating a pedal in a sitting position, is pedal riding. In such a situation, an operator may double hit the pedal, causing a multiplicity in operating the equipment, and possibly causing injury.

Such failures of operation may cause damage to the product of the manufacturer, the actual machine, or other operators or others standing by. Often, the only backup system is a stop button that an operator or other person needs to manually hit in order to stop the operation. If such an activation button is far from reach, it could be too far to prevent injury or damage.

Another problem that exists in existing manual systems is operator fatigue. Such fatigue may be a result of long working hours, redundant and repetitive operations, or the location or general ergonomics of the working environment. Such environment may cause carpal tunnel syndrome, backaches, and other injuries that are results of repetitive manual operations.

Some solutions exist that automate manufacturing systems, such as computer controlled automated systems, robotically operated systems, and other automated systems. Such systems, however, have drawbacks. Many manufacturing systems still require a human element in order to efficiently and effectively further the manufacturing process.

One solution that has been proposed is a voice controlled sewing machine. In such an application, voice controls are sent to the sewing machine via a microphone that is connected via cable to the sewing machine. This application, however, has many drawbacks. One drawback is the lack of mobility of an operator to control the sewing machine. Also, only one individual would be allowed to control the machine, the operator. If the operator is injured or somehow incapacitated, another person would need to assist in stopping the machine, and would not be able to prevent further injury. Also, such a system is not immune to outside noise sources that might trigger other controls of the sewing machine.

Therefore, there exists a need in the art for a voice controlled manufacturing system that overcomes the drawbacks of the prior art. As will be seen, the invention does this in an elegant manner.

### SUMMARY OF THE INVENTION

The invention provides a remote command system for controlling a device, for example a device or machine used in a manufacturing process. The system may include one headset with a microphone or a plurality of wireless headsets each having a microphone and configured to receive voice sounds from a user and a transmission unit configured to transmit voice signals in response to the voice sounds. A controller interface unit may be configured to receive the voice signals from the wireless headsets and to transmit control signals, where the controller interface is further configured to be trained to receive and interpret voice signals having personal characteristics of a user. A processor module is configured to receive the control signals from the controller interface unit to operate the device or machine.

### BRIEF SUMMARY OF THE DRAWINGS

FIG. 1 is a diagrammatic view of a remote control system configured according to the invention;

FIG. 2 is a more detailed diagrammatic view of a server of FIG. 1;

FIG. 3 is a diagrammatic view of a hierarchical remote control system configured according to the invention;

FIG. 4 is an illustration of a graphical user interface (GUI) for use in conjunction with a system configure according to the invention; and

FIG. 5 is an illustration of a graphical user interface (GUI) for use in conjunction with a system configure according to the invention.

### DETAILED DESCRIPTION

The invention is directed to a wireless voice command system configured for use in manufacturing or factory environments. In one embodiment of the system, it includes a processor module for processing voice command signals, an interface module for receiving and sending voice command data, a wireless headset for use by an operator in operating the system, and application software that allows the system to adapt itself to the environments in which manufacturing devices are controlled. Utilizing the invention, an operator has extended mobility, where the wireless headset can be carried by an operator, allowing the operator to control a device from a distance.

Many implementations of the controls are possible, given conventional components available. In one embodiment, the system can be made mobile, such as mounted on a movable cart, where the operator or other person can take the system and quickly connect it to any voice-enabled machine. Such a system would minimize clutter on the manufacturing floor, and maximize flexibility of a device, a system, and its operators. Depending on the application, different configurations of command modules are possible, such as mobile units that allow an operator to set up a command center at a location that gives access to a device, where the device may stand alone, may be connected to other devices or a system.

In another embodiment, the system allows for multiple operators to use a headset, where authorization of commands can be separately defined according to a hierarchical rule base. In this embodiment, different people can have different clearance authorizations to control a device, a system, or combinations of devices and systems. Such a configuration would allow a supervisor, for example, to stop any one device in a number of devices within a manufacturing process or general area or work cell. Also, it may allow a supervisor to step in and command an ongoing process during operator changeover or in the event of a system or device failure.

Utilizing the invention, voice commands in a manufacturing environment would drive the equipment without the need for any hand or foot pedal activation. Of course, such manual activation can be used as a backup system, and safety procedures of a particular user or company may require it. The general operation of a system embodying the invention, however, may be controlled remotely using voice controls. For example, an emergency stop function can be implemented and designed to immediately interrupt processing of a manufacturing device, outside the normal product cycles or operations. This may be engaged by the device operator, a supervisor, or other person that would need to have control over the individual operator's device or a number of devices.

The invention is described herein in the context of different embodiments. It will be appreciated by those skilled in the art, however, that other useful applications of the invention may be implemented without departing from the spirit and scope of the invention, where the scope is defined in the appended claims and any equivalents.

The invention provides particular voice recognition grammars tailored to specific manufacturing operations, allowing an operator to isolate operations by using specific voice commands. Such commands would not interfere with existing controls, including safety equipment such as light curtains, guarding devices, and other safety equipment.

In operation, a microphone operates within an environment that includes noise, vibration, and other hostile process factors that typically would cause problems with a voice activated system in conventional systems. According to the invention, however, these are overcome by using a unique wireless system for use by an operator in such an environment. In this wireless device, high frequency communications are used to transmit control signals from an operator's headset to a receiver or interface, allowing an operator to operate a device in an environment, even in the presence of the harsh environmental factors. This gives the operator more mobility, allowing the operator to walk about the device or manufacturing system while controlling the device or entire system. The headset may be configured to control a single device, or, alternatively, may be configured to operate multiple devices. This would allow management to have oversight control over a system, and possibly a backup person in the event of an emergency may be able to stop the process under certain circumstances. Such a system also reduces operator fatigue, requiring nothing but a voice activation in order to operate the machinery. This would also allow physically disabled operators to operate machines or other devices, regardless of their physical impairment.

In another embodiment of the invention, the system may be used for assisted living for a physically disabled person. In such a system, emergency alerts may be enabled by a voice activation by the operator. In such a situation, a disabled person may use voice activation to allow certain things to occur, such as notifying emergency help, unlocking doors, turning appliances on and off, turning lights on and off, flushing toilets, and other operations that are difficult for physical disabled people. More luxury items may also be available to disabled people, including operation of television, stereo, telephones, such as setting up conference calls with family members, and other operations. Such assisted living application of the invention allows for a great deal of independence for a disabled person, which can give great freedom in any environment or culture. In certain cultures, disabled persons are looked down upon, giving them less freedom of access to places, services, and operations. Utilizing the invention, a disabled person can have freedom of movement and access, particularly around the disabled persons home, allowing private and independent living.

Many other applications may exist that can utilize the invention, but the invention is not limited to the particular embodiments enclosed herein. Those skilled in the art will understand that the invention has many applications, many of which are easily contemplated by those skilled in the art.

In one field application, the invention was employed in a manufacturing process, which included a welding process, and the system was able to operate in a 93 dB (decibel) environment. In operation, there was no interference with the operation of the process, which included a loud overhead public access system.

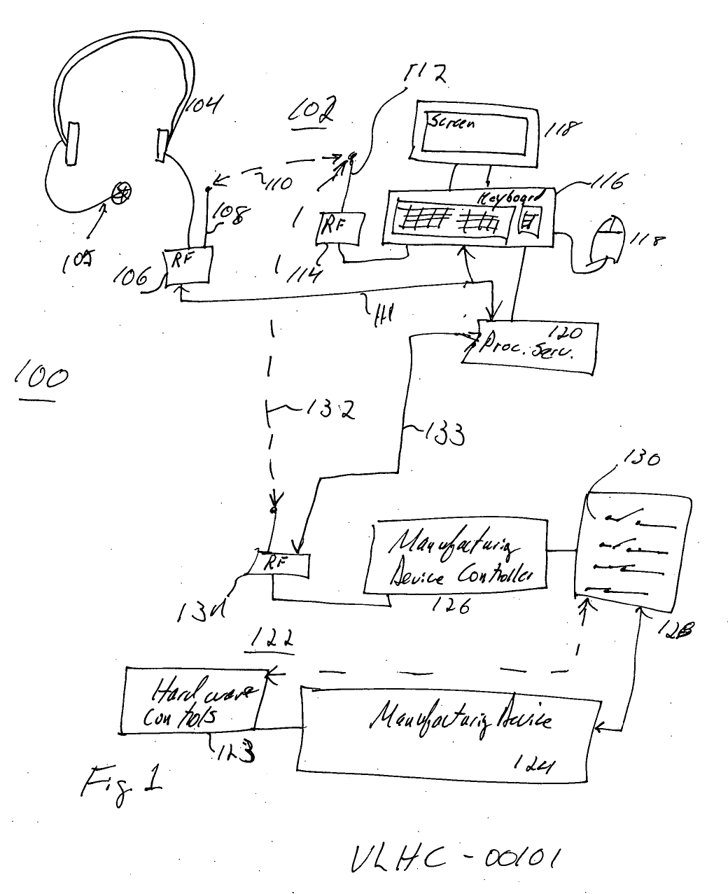

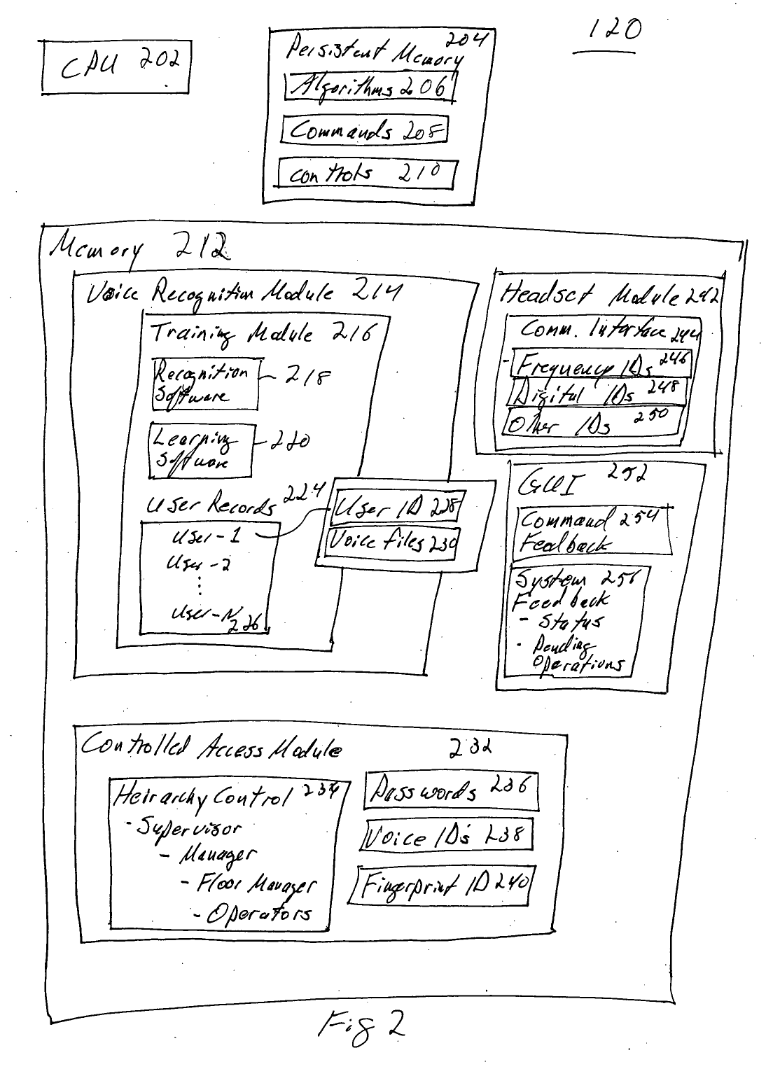

Referring to FIG. 1, one embodiment of the invention is illustrated. The system 100 includes a workstation subsystem 102, which includes a headset 104 that is worn by an operator that includes a microphone 105. The microphone is preferably configured to receive voice commands from a user, yet able to filter out or otherwise be unaffected by outside noise, such as that experienced in many factory environments. The headset may be connected to a transmitting module 106, such as a radio frequency (RF) transmitter/receiver that sends radio frequency signals. Such a module would include some type of antenna 108 for transmitting signals 110 to another RF transmitter/receiver 114 for sending and receiving signals from a remote antenna 112. Alternatively, depending on the configuration, a wire 111 may be connected between the module 106 and module 114, or processor server 120 to send and receive signals. The system further includes a keyboard 116 and corresponding monitor 118 for use by an operator to monitor the operations of the system 100. The processor 120 is configured to monitor and run the normal operations of the system 100, and can be configured to adapt to voice commands and other operations. This is discussed in more detail below in connection with FIG. 2. The second subsystem, which is located close to the manufacturing device 124, is a manufacturing device controller 126 configured to control the operations of the manufacturing device. In one embodiment, the controller is configured to control relay switches 130, which are commonly found in manufacturing systems. The subsystem 102 communicates with the second subsystem 122 via a signal 132, or, alternatively, via a wire 133, either of which may communicate with or be connected to module 134.

According to one embodiment, the software used for operations includes state-dependent structuring of the code. This allows different commands to be active depending upon the machine or control state. In a complex system, such as that discussed below, this can be useful when multiple commands are used in a system.

Also, different alerts can be used for feedback to a user or different levels in a hierarchical system, such as audible sounds like alarms. For example, an audible and rapid notification of recognition failure is useful if a user states a command that is not recognized by the system. A user can then restate the command, or retrain the system to recognize the unique voice characteristic in the command for future use.

Also, visual feedback in a GUI system can be used for feedback of error or success, and can be visible at an operator station, or from a distance for the operator or other users. For important alerts, full-screen color images can be generated for emergency/non-operational, error, and success states, depending on the application.

Also, various safeguards can be incorporated into a system to ensure safety and efficiency. For example, a system can be configured for automatic reversion to a “safe” state within a user-defined “quiet” window. This would allow a safe return to a state where a device or system can revert until a user can restart the operations. Also, a system can be configured for forced manual enabling, such as a mouse click for example, to support voice commands. This would allow for a secondary safety mechanism to ensure a proper command is issued by a user, particularly in a dangerous operation. Start-up states can also be configured in a state that is in a safe mode, where commands can have a starting point to proceed. Also, the system can be configured in a powerfail recovery, where the system starts up in a mode that is proper, safe and efficient for a process to begin after a power or other operational failure. In one embodiment, the system provides controlled and emergency shutdown processes, wherein predetermined processes are configured to shut down a process according to a predetermined protocol.

In one embodiment, a series of modules are configured to drive a valid result, such as a text string, to either a port address or a keyboard buffer, for integration into larger integrated manufacturing systems. This adds voice command functionality to existing machines. Existing signal connections can be used to mimic the operations of foot pedals or pushbuttons. Integration at the software level enables a larger variety of voice commands to address a much larger and more complex set of functions.

Referring to FIG. 2, a more detailed diagrammatic view of a process server 120 of FIG. 1 is illustrated. The server includes a central processing unit 202, configured to process software stored in persistent memory 204 or other memory sources, either internal or external to the server. The persistent memory may contain software stored for execution by the server, including algorithms 206 to enable the processor to perform predetermined algorithms using data received by the user's microphone, mouse 118, keyboard 116 or other input sources. It may also include commands 208 that may be predetermined software that, when executed by the processor may cause a device, such as manufacturing device 124, to perform certain predetermined or routine functions, including starting, stopping, performing operations and other functions. Controls 210 may be included for predetermined or routine operations such as power control, process routine safety operations, and other operations. Either or all of these operatives in the persistent memory may have overlapping duties, and may be used interchangeably, and those skilled in the art will understand that different operative components may be stored in various types of memory for use by the CPU, including these and other operations further discussed below.

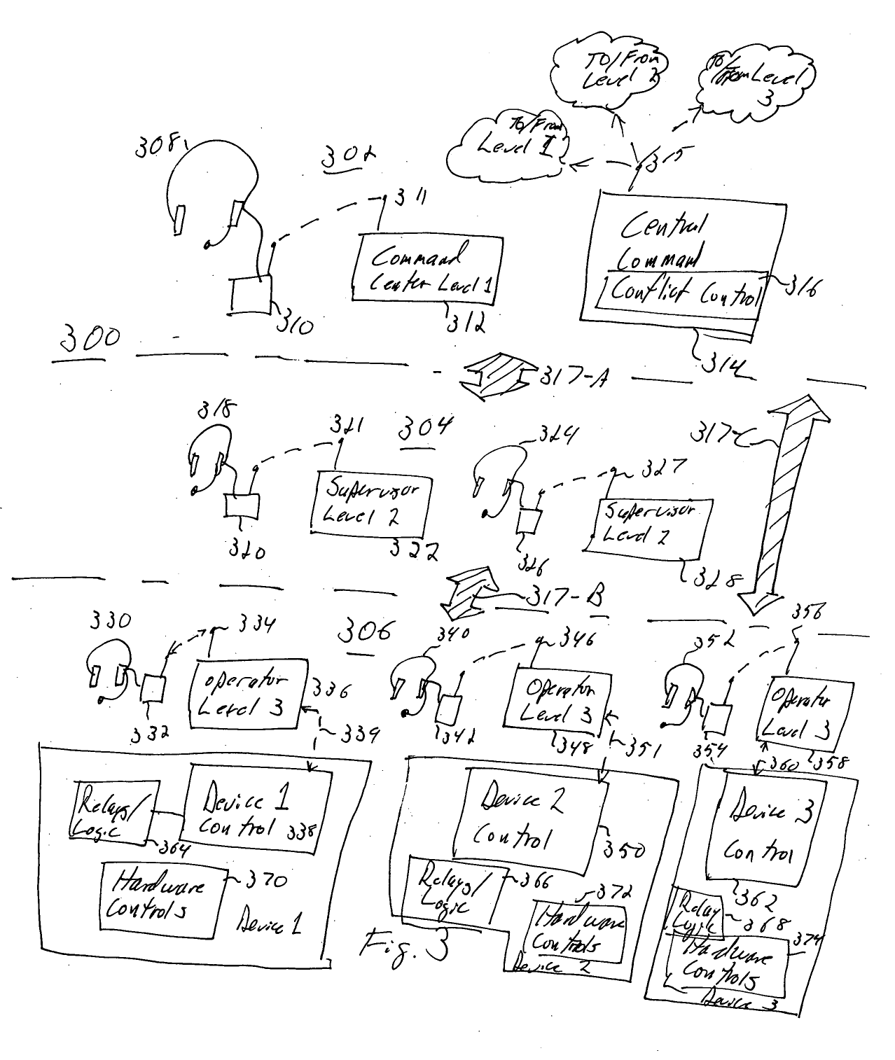

Server 120 further includes memory 212 that contains software that, when executed by the CPU, performs operations that enable systems configured according to the invention to manage and control manufacturing processes. Such systems may include the system 100, FIG. 1, as well as multiple systems that work in parallel and in a hierarchical manner. Referring to FIG. 3, another embodiment of the invention is illustrated, where multiple levels of commands arranged in a hierarchy is illustrated. In this embodiment, a robust system of control emanating from the different levels provides a uniquely useful control system with substantial safeguards. The system 300 is illustrated with 3 levels 302,304,306, but can be expanded to even more levels, and even to multiple manufacturing lines, where the command grid is two or even three dimensional. Those skilled in the art will understand that the basic concepts illustrated in and described in this specification can be expanded using well known organizational methods, such as those in supply chain control systems, in order to control more complex manufacturing configurations.

Still referring to FIG. 3, the top level, Level 1 302, includes a headset and microphone 308 that has a transmitter 310 for communicating to command center 312 via link 311 (which may be a RF signal transmitter/receiver or a communication wire), which may be configured similarly to process server 120 of FIG. 1. The command center may be configured with the control access that is superior to other levels, so that a central command monitor, such as a plant manager or high level supervisor, can have high level control over one or more devices, as well as one or more manufacturing processes. The command center 312 may communicate with a central command 314 that is configured to control the hierarchy of the system 300. It may also include conflict control operations 316 to control potential conflicts among the participants or users in the system 300 that may have overlapping or unforeseen authority that may conflict with others. The central command may communicate throughout the system 300 levels via an antenna 315, that may send signals to each of the levels 302,304,306 and also receive signals and relay them to particular users. It may also serve to relay other command signals such as GUI information, sound information and other information pertinent to system and sub-system operations. The central command 314 may be a fully or partially radio system or may be fully or partially wired into a system depending on the application. The central command may enable each level to communicate to other levels via communication channels 317-A,B,C, which may be censored or otherwise controlled according to a hierarchical configuration, which may be defined at a central server or other device configured for such operation.

Level 2, 304, may include a second level of management or supervision below Level 1, 302, and may included one or more users. User headset/microphone 318 includes a transmitter/receiver 320 that communicates using the communication channel 321 to the supervisor level 2 processor 322. Similarly, user headset/microphone 324 includes a transmitter/receiver 326 that communicates using the communication channel 327 to the supervisor level 2 processor 328. Again, the Level 2 system may include one or more users, such as the two shown, and may include controlled access authority that is subservient to Level 1 command, and that is superior to the authority established for Level 3, 306, users.

Level 3, 306, may include multiple user headset/microphones 330,340,352 that communicate with transmitter/receivers 332,342,354 via communication channels 334,346,352 (antennas or wires) to operator servers 336,348,358 respectively. These in turn communicate with devices systems, Device 1,2,3, via communication channels 339,351,360 to device controls 338,350,362. The devices may include relays 364,366,368 and hardware controls 370,372,374 that serve as a backup or complement to the control systems in general.

Referring again to FIG. 2, the control system may control a single system, such as illustrated in FIG. 1, or a multi-level system such as illustrated in FIG. 3. The process server 120 may serve as a server at any level, and can be configured differently for each level to establish and maintain the hierarchy of the system under control. Voice recognition module 214 includes training module 216 for training a user's voice to communicate commands, whether for controlling a single device or for use at different levels of the hierarchical system. The system may be a centralized system, where the voice recognition module governs the training and management of the voice recognition for all users, or may be a distributed system, where each user trains its own subsystem at disparate locations where users reside. Those skilled in the art will understand that many configurations and orientations may be developed to expand the scope of such a system using known methods as well as methods easily inferred by this specification and accompanying drawings.

Still referring to FIG. 2, the training module 216 is configured with recognition software 218 that is configure to recognize a user's voice and related characteristics that are used to identify certain commands for use in a system configured according to the invention. Learning software 220 is configured to allow the training module to learn a user's personal characteristics. This can be done by running a user through a training process, such as repeating predetermined words, phrases and passages, and recording the user's voice sounds that are unique to a user's voice when speaking certain words. Also, specific commands can be spoken by a user and recorded by the system so that specific commands can be easily recognized by the system when a user is speaking commands. Many different types of speech recognition and speech learning software exists, such as that developed by Nuance Communications™, Dragon™, and other companies that produce and develop such software. The invention is, not limited to any particular application product, but systems configured according to the invention can incorporate these or other products. User records 224, User-1, User-2, . . . User-N, may be stored centrally or distributed to different locations in a system, where user IDs 228 and voice files 230 may be created for each user. The voice files may include commands that are single words, phrases, numbers or other identifying voice commands that a user can use to operate a system, or that any user can use within the hierarchical system to send commands or instructions. The system may include verbal feedback from other users in a system, where the system is integrated with an overall communication network of users in the system to communicate. Such a system could include safeguards against unintentional commands that may be used in conversation, such as using unnatural speech codes that are not normally used in conversation, for example, saying “command-1, start system” as a command.

The memory 212 may include controlled access module 232 in the case of a hierarchical system, such as that illustrate in FIG. 3 and discussed above. Such a module can establish different access privileges for different users in the hierarchy, such as supervisors, managers, floor managers and operators, depending on the hierarchy of the management and supervision of the manufacturing system that is under control of the system 300, FIG. 3. In such a system, passwords 236, voice identifiers 238 and/or fingerprint identifications 240 can be used alone or in combination to safeguard access to the hierarchy of control and to avoid any tampering or manipulation that may impinge on the integrity of the system.

Memory 212 may include headset module 242 configure to interface with each user's headset, and may include communication interface 244. The interface is configured to distinguish among the several headsets in a system, and can do so using different frequency identifiers 246, which may be simple analog or digital circuits, or combinations of the two, that can identify different frequencies. Different headsets may have different frequencies within a certain frequency band, and the communication interface can distinguish commands from different users by the unique frequency assigned to and transmitted from a particular user's headset. Other mechanisms are possible for recognizing different user headsets, such as digital identifiers 248, which may be simple digital information transmitted from users, or other identifiers 250 that are well known in the art.

As can be seen, the wireless interface is able to send control signals to an interface, where the interface has voice control recognition. Many different types of voice recognition software exist in the art, and the invention is not limited to any particular type of voice recognition software. Continuing, the system is able to receive the control commands from the voice of the operator, interpret the commands with the voice recognition software, and then enable the operation of the device according to the voice commands.

For example, an operator may say “start” which will begin the process, and may also later include later commands during the process, and may further include, an “end” command in order to stop operations. Such a command may be configured according to the application, where a single device may be stopped, or multiple devices may be stopped, depending on the particular application or desires of the operators or managers of operators. In one embodiment, different headsets send different signals, allowing operators and managers to have separate authority over individual machines or groups of machines. In another embodiment, the system may be configured such that only certain commands will be active at different stages of the operating process. For example, the processor may be configured to deactivate a “start” command during a set up stage of the process so as to prevent an injury or damage to the machine should the command be inadvertently given while the machine is still being readied for operation. Such a system may be used by an operator to set up, cycle, interrupt processing, make changes to power levels and material feed rates, and other types of operations needed in a particular manufacturing process.

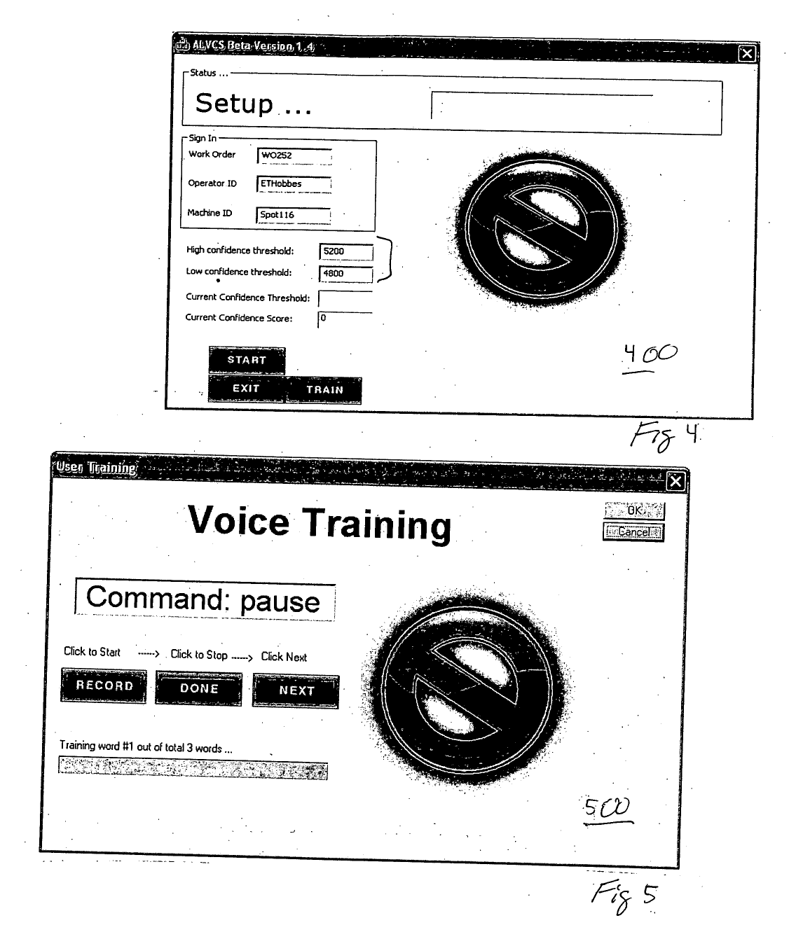

FIG. 4 is an illustration of a graphical user interface (GUI) for use in conjunction with a system configure according to the invention. FIG. 5 is another illustration of a graphical user interface (GUI) for use in conjunction with a system configure according to the invention. Many different user interfaces can be used as additional feedback to a user, whether during setup, voice training, or also during operation of the system, for example showing a large “STOP” command on a GUI to indicate an important event such as a system shutdown or an “EMERGENCY” shut down of the system. Many different commands can be augmented in this manner, and many variations are possible.

In one embodiment, a system is provided for a remote command system for controlling a process that includes a wireless headset having a microphone configured to receive voice sounds from a user and a transmission unit configured to transmit voice signals in response to the voice sounds. A controller interface unit is configured to receive the voice signals from the wireless headset and to transmit control signals, the controller interface further configured to be trained to receive and interpret voice signals having personal characteristics of a user. And, a processor module configured to receive the control signals from the controller interface unit to operate a process. In one embodiment, the system further includes a plurality of wireless headsets configured to transmit voice commands from a user, wherein the plurality of wireless headsets may operate on separate frequencies to enable the controller interface to distinguish voice signals from different users.

In another embodiment, the system further includes a plurality of wireless headsets configured to transmit voice commands from a user, wherein the plurality of wireless headsets may operate on separate frequencies to enable the controller interface to distinguish voice signals from different users. In another embodiment, the system further includes a plurality of wireless headsets configured to transmit voice commands from a user, wherein the plurality of wireless headsets may operate with different identification signals to enable the controller interface to distinguish commands received from different users. In another embodiment, the system further includes a plurality of wireless headsets configured to transmit voice commands from a user, wherein the plurality of wireless headsets may operate with different voice recognition records to enable the controller interface to distinguish voice signals from different users. In another embodiment, the system further includes a plurality of wireless headsets configured to transmit voice commands from a user, wherein the wireless headsets may be configured to operate in a plurality of different acoustic environments. In another embodiment, the system further includes a plurality of wireless headsets configured to transmit voice commands from a user, wherein the wireless headsets are configured with a directional noise-cancelling microphone.

In another embodiment, the system further includes a plurality of wireless headsets configured to transmit voice commands from a user, wherein the wireless headsets are configured to be one of monaural and binaural design. In another embodiment, the system further includes a plurality of wireless headsets configured to transmit voice commands from a user, wherein the wireless headsets may be configured to control multiple devices. In another embodiment, the system is configured to be integrated with existing control and safety circuitry in a user work area. In another embodiment, the system further includes an emergency stop voice command for increased site safety. In another embodiment, the system further includes an override voice command for increased site safety. In another embodiment, the system further includes a two step activation confirmation voice command to prevent accidental activation of the manufacturing process for increased site safety.

In another embodiment, the system further includes a programmable shut down status timer that would measure idle time between operations and reset the machinery to an inactive non-listening state to prevent accidental activation of an operation by an operator. In another embodiment, the system further includes a processor configured to interpret voice signals using speaker independent voice recognition technology. In another embodiment, the system further includes a processor configured to interpret voice signals using Natural Language Understanding (NLU) technology. In another embodiment, the system further includes a processor configured with an embedded voice recognition platform, and wherein the voice recognition platform contains a dictionary of robust command grammar designed for high recognition and low error rates. In another embodiment, the system further includes a dictionary of robust command grammar configured to recognize multi-word phrases and single word commands. In another embodiment, the system further includes a processor configured with speaker verification to ensure that only authorized operators can operate the machine for increased safety and security. The speaker verification may requires an operator to provide a secondary command after a first command to verify the first command.

In another embodiment, the system further includes a processor the system may be operated in parallel with manual controls for testing, setup, and production functions. The operator may be provided audible, positive feedback of each command. The operator may be provided visual feedback of a command. An ASCII log file is generated at each station. The ASCII log file includes time and date, current level of the state machine prior to the command, command text as interpreted by the system, and ending state.

The system may include upper and lower command thresholds that define the range in which a command will be transmitted and used to enable a command to be performed, and the upper and lower command thresholds may be programmable.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of computers, such as computer servers, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The apparatus and method include a method and apparatus for enabling and remotely controlling a device or system of multiple device. Although this embodiment is described and illustrated in the context of devices, systems and related methods of processing machines and related devices, the scope of the invention extends to other applications where such functions are useful. Furthermore, while the foregoing description has been with reference to particular embodiments of the invention, it will be appreciated that these are only illustrative of the invention and that changes may be made to those embodiments without departing from the principles of the invention.

1. A remote command system for controlling a process, comprising;
a wireless headset having a microphone configured to receive voice sounds from a user and a transmission unit configured to transmit voice signals in response to the voice sounds;
a controller interface unit configured to receive the voice signals from the wireless headset and to transmit control signals, the controller interface further configured to be trained to receive and interpret voice signals having personal characteristics of a user; and
a processor module configured to receive the control signals from the controller interface unit to operate a process.

2. A system according to claim 1, further comprising a plurality of wireless headsets configured to transmit voice commands from a user, wherein the plurality of wireless headsets may operate on separate frequencies to enable the controller interface to distinguish voice signals from different users.

3. A system according to claim 1, further comprising a plurality of wireless headsets configured to transmit voice commands from a user, wherein the plurality of wireless headsets may operate on separate frequencies to enable the controller interface to distinguish voice signals from different users.

4. A system according to claim 1, further comprising a plurality of wireless headsets configured to transmit voice commands from a user, wherein the plurality of wireless headsets may operate with different identification signals to enable the controller interface to distinguish commands received from different users.

5. A system according to claim 1, further comprising a plurality of wireless headsets configured to transmit voice commands from a user, wherein the plurality of wireless headsets may operate with different voice recognition records to enable the controller interface to distinguish voice signals from different users.

6. A system according to claim 1, further comprising a plurality of wireless headsets configured to transmit voice commands from a user, wherein the wireless headsets may be configured to operate in a plurality of different acoustic environments.

7. A system according to claim 1, further comprising a plurality of wireless headsets configured to transmit voice commands from a user, wherein the wireless headsets are configured with a directional noise-cancelling microphone.

6. A system according to claim 1, further comprising a plurality of wireless headsets configured to transmit voice commands from a user, wherein the wireless headsets are configured to be one of monaural and binaural design.

8. A system according to claim 1, further comprising a plurality of wireless headsets configured to transmit voice commands from a user, wherein the wireless headsets may be configured to control multiple devices.

9. A system according to claim 1, wherein the system is configured to be integrated with existing control and safety circuitry in a user work area.

10. A system according to claim 1, further including an emergency stop voice command for increased site safety.

11. A system according to claim 1, further configured with an override voice command for increased site safety.

12. A system according to claim 1, further configured with a two step activation confirmation voice command to prevent accidental activation of the manufacturing process for increased site safety.

13. A system according to claim 1, further configured with a programmable shut down status timer that would measure idle time between operations and reset the machinery to an inactive non-listening state to prevent accidental activation of an operation by an operator.

14. A system according to claim 1, wherein the processor is configured to interpret voice signals using speaker independent voice recognition technology.

15. A system according to claim 1, wherein the processor is configured to interpret voice signals using Natural Language Understanding (NLU) technology.

16. A system according to claim 1, wherein the processor is configured with an embedded voice recognition platform, and wherein the voice recognition platform contains a dictionary of robust command grammar designed for high recognition and low error rates.

17. A system according to claim 16, wherein the dictionary of robust command grammar is configured to recognize multi-word phrases and single word commands.

18. A system according to claim 1, wherein the processor is configured with speaker verification to ensure that only authorized operators can operate the machine for increased safety and security.

19. A system according to claim 18, wherein the speaker verification requires an operator to provide a secondary command after a first command to verify the first command.

20. A system according to claim 1, wherein the system may be operated in parallel with manual controls for testing, setup, and production functions.

21. A system according to claim 1, wherein the operator is provided audible, positive feedback of each command.

22. A system according to claim 1, wherein the operator is provided visual feedback of a command.

23. A system according to claim 1, wherein an ASCII log file is generated at each station.

24. A system according to claim 23, wherein the ASCII log file includes time and date, current level of the state machine prior to the command, command text as interpreted by the system, and ending state.

25. A system according to claim 1, wherein the upper and lower command thresholds are programmable.
